(19) United States
(12) Patent Application Publication
(10) Pub. No.: US 2009/0060547 A1
(43) Pub. Date: Mar. 5, 2009

(54) Transfer Belt Charge Buildup Compensation

(76) Inventors: Paul Etter, Lexington, KY (US); Julie Ann Gordon Whitney, Georgetown, KY (US); Kerry Leland Embry, Midway, KY (US); Robert Reed Booth, Lexington, KY (US)

Correspondence Address: John J. McArdle, Jr.;Lexmark International, Inc., Intellectual Property Department, 740 West New Circle Road, Lexington, KY, 40550, US

(21) Appl. No.: 11/849,596

(22) Filed: Sep. 4, 2007

(51) Int. Cl. G03G 15/16

(52) U.S. Cl. 399/66

(57) ABSTRACT

The present application is directed to methods and devices for compensating for transfer belt charge buildup in an image forming device. In one embodiment, the method includes determining the charge buildup on the transfer belt due to an applied transfer voltage. A first image of a multi-image print job is printed using a first transfer voltage. The transfer voltage may then be adjusted for printing one or more subsequent images of the multi-image print job.

### BACKGROUND

The present application is directed to image forming devices and, more specifically, to methods and devices for adjusting a transfer voltage to compensate for charge buildup on a transfer belt.

Image forming devices may use an electrophotographic imaging process to develop toner images on a media sheet. The electrophotographic process uses electrostatic voltage differentials to promote the transfer of toner from component to component. For example, a voltage differential may exist between a developer roll and a latent image on a photoconductive member. This voltage differential helps promote the transfer of toner from the developer roll to the latent image to “develop” the image. A separate voltage differential may exist within a transfer nip formed between the photoconductive member and a transfer roller to promote the transfer of a developed image onto a media sheet. In each instance, the toner transfer occurs in part because the toner itself is charged and attracted to surfaces having an opposite charge.

In certain image forming devices, a transfer belt may convey the media sheet through the transfer nip. The transfer roller may be in contact with the transfer belt on an opposite side of the belt from the photoconductive member and the media sheet. Because the transfer roller may be advantageously charged to promote the transfer of the developed image, a charge may build up on the belt. This charge may alter the effective transfer voltage between the transfer roller and photoconductive member, degrading the effectiveness of the toner transfer.

### SUMMARY

The present application is directed to methods and devices for compensating for transfer belt charge buildup in an image forming device. In one embodiment, the method includes determining the charge buildup on the transfer belt due to an applied transfer voltage. A first image of a multi-image print job is printed using a first transfer voltage. The transfer voltage may then be adjusted for printing one or more subsequent images of the multi-image print job.

### BRIEF DESCRIPTION OF THE DRAWINGS

FIG. 1 is a schematic diagram of an image forming device according to one embodiment.

FIG. 2 is a schematic diagram of an image forming unit of an image forming device according to one embodiment.

FIG. 3 is a process diagram for a control process according to one embodiment.

FIG. 4A is a process diagram for a control process according to one embodiment.

FIG. 4B is a process diagram for a control process according to one embodiment.

FIG. 5 is a process diagram for a control process according to one embodiment.

### DETAILED DESCRIPTION

The present application is directed to methods and devices for dynamically compensating for transfer belt charge buildup in an image forming device. In one embodiment, the method includes determining the charge buildup on the transfer belt due to an applied transfer voltage. A first image of a multi-image print job is printed using a first transfer voltage. The transfer voltage may then be adjusted for printing one or more subsequent images of the multi-image print job. The adjusted transfer voltage may compensate for charge buildup on the transfer belt due to the applied transfer voltage.

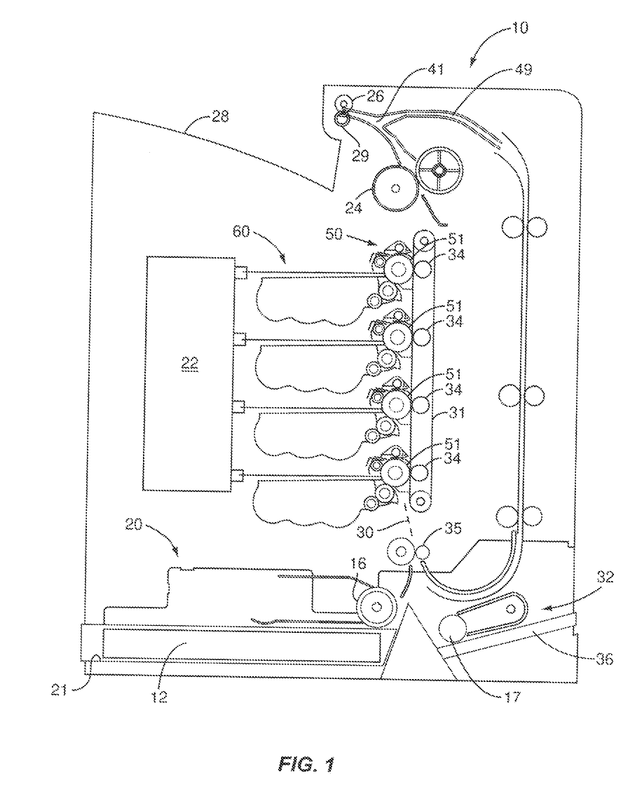

To understand the context of the present application, FIG. 1 illustrates a representative image forming device 10. An input area 20 includes an input tray 21 to receive a stack of media sheets 12. A contact roller 16 may be positioned adjacent to the input tray 21 to contact and introduce the media sheets 12 into a media path 30. The input area 20 may also include a multipurpose feeder 32. The multipurpose feeder 32 may include a support surface 36 to support one or more media sheets 12, and a contact roller 17 to contact and move the media sheets 12 into the media path 30.

Media sheets 12 are moved from the input area 20 and fed into the media path 30. One or more registration rollers 35 align each media sheet 12 and precisely control its further movement along the media path 30. A media transfer belt 31 forms a section of the media path 30 for moving the media sheets 12 past a plurality of image forming units 60. Color printers typically include four image forming units 60 for printing with black, magenta, cyan, and yellow (although not necessarily in that order) toner to produce a color image on the media sheet 12.

An imaging device 22 forms a latent image on a photoconductive member 51 within each image forming unit 60 as part of the image formation process. The media sheet 12 with loose toner is then moved through a fuser 24 that applies heat and pressure to adhere the toner to the media sheet 12. An exit roll 26 forming a nip with a nip roll 29 is positioned at an output area. The exit roll 26 rotates in a forward direction to expel the media sheet 12 from the device 10 and out to an output tray 28. Alternatively, the exit roll 26 may rotate in a forward direction for a limited time until a trailing edge of the media sheet 12 passes an intersection point 41 along the media path 30. The exit roll 26 is then rotated in a reverse direction to drive the media sheet 12 into a duplex path 49. The duplex path 49 directs the inverted media sheet 12 back through the image formation process for forming an image on a second side of the media sheet 12.

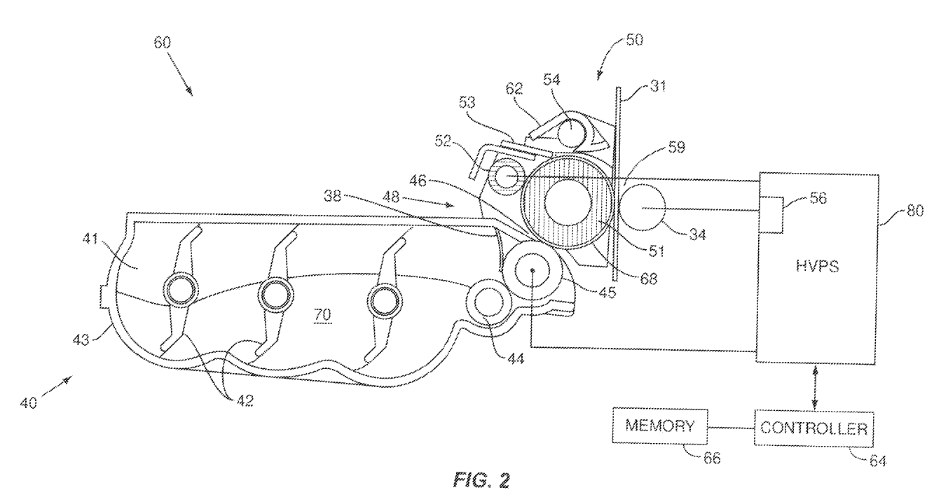

FIG. 2 illustrates that the image forming units 60 comprise a developer unit 40 and a photoconductor (PC) unit 50. The developer unit 40 comprises an exterior housing 43 that forms a reservoir 41 for holding a supply of toner 70. One or more agitating members 42 are positioned within the reservoir 41 for agitating and moving the toner 70 towards a toner adding roll 44 and the developer member 45. The developer unit 40 further comprises a doctor element 38 that controls the toner 70 layer formed on the developer member 45. The developer unit 40 and PC unit 50 are structured so the developer member 45 is accessible for contact with the photoconductive member 51 at a nip 46. Consequently, the developer member 45 is positioned to develop latent images formed on the photoconductive member 51 with toner 70.

The exemplary PC unit 50 comprises the photoconductive member 51, a charge roller 52, a cleaner blade 53, and a waste toner auger 54 each disposed within a housing 62 that may be separate from the developer unit housing 43. In one embodiment, the photoconductive member 51 is an aluminum hollow-core drum with a photoconductive coating 68 comprising one or more layers of light-sensitive organic photoconductive materials. The photoconductive member 51 is mounted protruding from the PC unit 50 to contact the developer member 45 at nip 46. Charge roller 52 is electrified to a predetermined bias by a high voltage power supply (HVPS) 80 that is adjusted or turned on and off by a controller 64. The charge roller 52 applies a uniform electrical charge to the photoconductive coating 68. During image creation, selected portions of the photoconductive coating 68 are exposed to optical energy, such as laser light, through aperture 48. Exposing areas of the photoconductive coating 68 in this manner creates a discharged latent image on the photoconductive member 51. That is, the latent image is discharged to a lower charge level than areas of the photoconductive coating 68 that are not illuminated.

The developer member 45 (and hence, the toner 70 thereon) is charged to a bias level by the HVPS 80 that is advantageously set between the bias level of charge roller 52 and the discharged latent image. Charged toner 70 is carried by the developer member 45 to the latent image formed on the photoconductive coating 68. As a result of the imposed bias differences, the toner 70 is attracted to the latent image and repelled from the remaining, higher charged portions of the photoconductive coating 68. At this point in the image creation process, the latent image is said to be developed.

The developed image is subsequently transferred to a media sheet 12 being carried past the photoconductive member 51 by media transfer belt 31. In the exemplary embodiment, a transfer roller 34 is disposed behind the transfer belt 31 in a position to impart a contact pressure at a transfer nip 59. In addition, the transfer roller 34 is advantageously charged, typically to a polarity that is opposite the charged toner 70 and charged photoconductive member 51 to promote the transfer of the developed image to the media sheet 12.

In one embodiment, the charge roller 52, the photoconductive member 51, the developer member 45, the doctor element 38 and the toner adding roll 44 are all negatively biased. The transfer roller 34 may be positively biased to promote transfer of negatively charged toner 70 particles to a media sheet 12. Those skilled in the art will comprehend that an image forming unit 60 may implement polarities opposite from these.

A controller 64 may control the operating parameters of the imaging elements. The controller 64 may adjust the parameters based on feedback from one or more detection measures. In one embodiment, controller 64 sets the operating parameters based on stored values maintained in memory 66. In one embodiment, a transfer servo voltage that produces a predetermined current through the transfer roller 34 is determined. More specifically, the HVPS 80 includes a sensing circuit 56 adapted to sense the voltage transmitted to the transfer roller 34 that produces the target current. Periodically, the HVPS 80, under the control of controller 64, implements a transfer servo routine to determine the transfer servo voltage, which varies in relation to changing operating conditions. The printer controller 64 may adjust operating parameters (e.g., bias voltage applied to the transfer roller 34 or the fuser 24 shown in FIG. 1) based on the determined transfer servo voltage to compensate for changes in operating conditions.

The transfer servo voltage may vary within a print job and over longer periods of time. Factors that have been shown to affect the transfer servo include temperature, humidity, and age of the transfer belt 31. A simplified method to adjust the voltage applied to the transfer roller 34 to account for this variation may be initiated by performing a beginning-of-job (BOJ) transfer servo routine to measure the electrical resistance of a transport path through the transfer rollers 34 and the transfer belt 31. The transfer servo routine may be performed at one or more image forming units 60 in a color image forming device 10. The controller 64 uses the measured transfer servo voltage to determine a printing transfer voltage based on a predetermined relationship between servo voltage and transfer voltage. In this simplified method, the same transfer voltage is used for the duration of the print job, regardless of the total number of images printed.

However, as the transfer belt 31 ages, its resistance and capacitance may increase. The higher resistance may raise the transfer voltage needed for acceptable image transfer. The higher capacitance may result in charge buildup on the belt during printing, which effectively increases the resistance of the transfer belt 31 within the print job. The predetermined relationship between servo and transfer voltages used by the controller 64 may become increasingly inaccurate at the resistance and capacitance increase. Thus, adjustments made to the transfer voltage by the controller 64 may prove to be less effective over time.

A more complex method for adjusting the transfer voltage includes implementing a second servo routine between the third and fourth images of a multi-image print job. This method assumes that most of the charge buildup on the transfer belt 31 will occur during printing of the first three images. The transfer voltage may be readjusted after the third image, and all subsequent images printed with the adjusted transfer voltage value. This method may result in an extended gap between the third and fourth image due to the necessity of performing a servo routine, decreasing machine throughput and increasing the time the toner 70 is agitated.

An extension of this method includes performing an inter-page servo routine after each image and adjusting the transfer voltage for each image. In order to avoid excessive decreases in throughput, the inter-page servo may be performed when the trailing edge of the media sheet 12 clears the transfer nip 59. However, this results in the servo occurring at about the same point on the belt for each color plane. Because the transfer belt 31 tends to carry charge from each image forming unit 60, this method may tend to accurately adjust the transfer voltage for the first image forming unit 60, but may become increasingly inaccurate for the downstream image forming units 60.

The present application is directed to methods for actively tracking the amount of charge buildup for the transfer belt 31 and dynamically compensating for that buildup on each image of a multi-image print job. One embodiment includes developing normalized charge buildup profiles for a number of transfer belt 31 and transfer roller 34 combinations. By graphing these profiles, a generalized relationship between the image number of the print job and the necessary amount of transfer voltage adjustment can be developed. An example of a generalized relationship is shown in the following table:

| | Transfer Voltage |
|---|---|
| Image | Adjustment (percent) |
| 1 | 0 |
| 2 | 40 |
| 3 | 65 |
| 4 | 80 |
| 5 | 90 |
| 6 | 97 |
| 7 | 100 |
| 8 | 100 |
| 9 | 100 |
| 10+ | 100 |

In this example, the BOJ servo is 1200 V, and the charge buildup is 500 V. The first image would be printed using a transfer voltage of 1200 V. The second image would be printed with a transfer voltage of 1200 V+(40 percent of 500 V), or 1400 V. Transfer voltage for subsequent pages would be determined similarly.

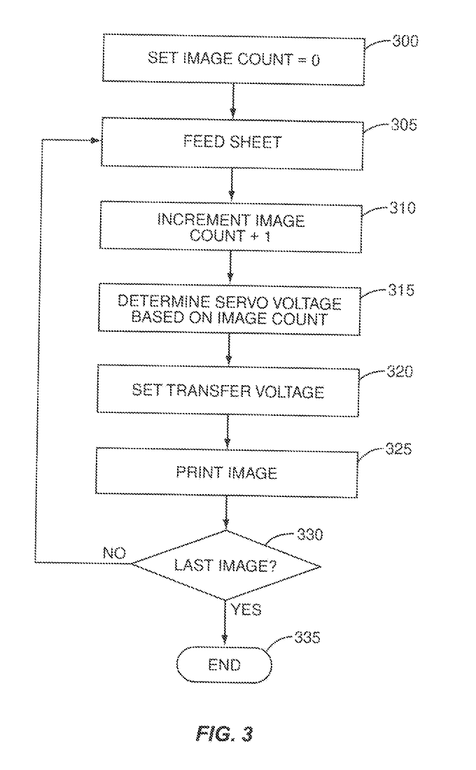

FIG. 3 illustrates the steps performed by the controller 64 to determine the transfer voltage adjustments according to this embodiment. The controller 64 sets the image count to zero (block 300) and gives a command to feed the next media sheet 12 (block 305). The image count is incremented by one (block 310). Using a table similar to that presented above, the controller 64 calculates the transfer voltage based on the image count (block 315). The transfer voltage is then adjusted to the calculated value (block 320) and the image is printed (block 325). The controller 64 then checks whether the image is the last image in the print job (block 330). If the image is not the last, then the next sheet 12 is fed (block 305) and the procedure is repeated. The process ends when the last image has been printed (block 335).

None of the embodiments described above takes into account that the charge buildup on the transfer belt 31 tends to decay over time, whether the time is that between printing each image or between each print job. In order to create a dynamic, real-time learning algorithm for determining the transfer voltage for each image of a multi-image print job, one embodiment may incorporate transfer belt 31 charge decay characteristics in addition to charge buildup characteristics. The decay profile of a given transfer belt 31 is generally consistent across different levels of charge buildup. In other words, the rate at which the charge decays is consistent regardless of the amount of charge buildup. However, the decay profile may be dependent on environmental conditions such as temperature and humidity. Experimentation has shown that a charge decay time constant can be calculated based on a servo performed at cold startup. In one embodiment, the charge decay time constant is in the range of about 0 to about 70. The charge decay time constant can then be incorporated into the algorithm. By characterizing the charge decay profile, a starting point for printing a subsequent image, or the amount the previous charge buildup has decayed, can be determined.

The image forming device may include more than one resistive element that may all be discharging simultaneously, such as the transfer belt 31 and the transfer roller 34. Therefore, a simple time decay algorithm in the form of 1−e^{(-t/τ}) where t is the time and τ is the charge decay time constant, does not accurately describe this system, and an alternate algorithm may be required.

In this embodiment, the following constants may be determined empirically for the system (with representative values in parentheses):
e_{c}—Belt charging logarithmic base (2.257±a predetermined amount)
τ_{c}—Belt charging time constant (1.7±a predetermined amount)
tₑₓₜ—Extrapolation time for predicting amount of pre-charge (600 sec)
   The following variables may be measured and/or tracked by the controller 64:
CSS—Cold-start servo
BOJₙ—Beginning-of-job servo voltage for most recent job number “n”
EOJₙ—End-of-job servo voltage for most recent job number “n”
PLₙ—Number of images of most recent job number “n”
tₙ—Idle time prior to most recent job number “n”
V1—Starting servo voltage for the current job
t₁—Idle time since most recent job
   The following variables may be calculated by the controller 64:
Propₙ—Proportion of full charge buildup achieved in number of images printed in job number “n”
τ_{d}—Belt discharging time constant
CUₙ—Characteristic charge buildup of belt predicted by job number “n”
C₀—Amount the belt is “pre-charged” for current job
P—Image number for the image being printed
Prop—Proportion of full charge buildup for the image being printed
S—Transfer for the image being printed

The alternate algorithm begins with collecting and storing data by the controller 64 for a predetermined number of previous print jobs to form a data set. These data include, for each of the black, magenta, and cyan image forming units 60, the BOJ servo, end-of-job (EOJ) servo, number of images in the print job, and the idle time prior to the print job. Using the data set, the controller 64 calculates Propₙ according to Equation 1 and CUₙ according to Equations 2 and 3. For the predetermined number of previous print jobs, the controller 64 calculates the average characteristic charge buildup, CU_{avg}.

$$\begin{matrix}{Prop}_{n} = 1.0 - {e}_{c}^{- ( {PL}_{n} / {τ}_{c} )} & Eqn . 1 \\ {τ}_{d} = ( 0.027 \times C S S ) - 18.816 & Eqn . 2 \\ C {U}_{n} = - {τ}_{d} \times ln ( \frac{{t}_{n}}{{t}_{ext}} ) + \frac{E O {J}_{n} - B O {J}_{n}}{{Prop}_{n}} & Eqn . 3\end{matrix}$$

The controller 64 then issues commands to the image forming device to print the first image of the print job using the starting servo voltage for the print job, V1. For each subsequent image, the controller 64 increments the servo voltage by the following calculations. First, the controller 64 calculates the proportion of full charge buildup, Prop, to be adjusted for the next image according to Equation 4. Next, the amount the belt is precharged for the current print job, C₀, is calculated according to Equation 5. Finally, the transfer voltage, S, is calculated according to Equation 6. The image is then printed using the calculated transfer voltage, and the process is repeated for each subsequent image of the print job.

$$\begin{matrix}Prop = 1 - {e}_{c}^{- ( P / {τ}_{c} )} & Eqn . 4 \\ {C}_{0} = - {τ}_{d} \times ln ( \frac{{t}_{1}}{{t}_{ext}} ) & Eqn . 5 \\ S = V 1 + ( Prop \times ( C {U}_{avg} - {C}_{0} ) ) & Eqn . 6\end{matrix}$$

Performing a servo routine after the yellow image forming unit 60 (or more generally, the last image forming unit 60 in a color image forming device) may result in excessively long delays between printing of images. As a result, data may not be available to calculate the adjusted servo value for the yellow image forming unit 60 as described above. However, in one embodiment, the charge buildup for the yellow image forming unit 60 is similar to the charge buildup for the cyan image forming unit 60 where cyan immediately precedes yellow. Consequently, the servo adjustment for the yellow image forming unit 60 will match the servo adjustment for the cyan image forming unit 60 according to Equation 7.

S_{yellow,P}=V1_{yellow}+(S_{cyan,P}−C₀) Eqn. 7

In one embodiment, the data set stored by controller 64 includes only the predetermined number of previous print jobs. The charge buildup characteristics of the transfer belt 31 may change with time. Therefore, the data stored may be the most recent previous print jobs to more accurately reflect the current condition of the transfer belt 31. As data for the latest previous print job is stored, the controller 64 discards the data for the oldest previous print job.

When the print job includes only a single image, the transfer belt 31 may not achieve the full charge buildup. The calculated average characteristic charge buildup, CU_{avg}, may not accurately reflect the average charge buildup for multi-image print jobs when the calculated average includes charge buildup values for these single-image print jobs. While CU_{avg} can be calculated using the characteristic charge buildup values for single-image print jobs, higher accuracy may be obtained using data for only multi-image print jobs. Therefore, in one embodiment the controller 64 does not store data for single-image print jobs.

In another embodiment, the controller 64 includes a predetermined maximum amount that the servo voltage may be adjusted. This maximum adjustment value prevents overcompensation of the servo voltage due to corrupted or inaccurate data or other errors in the controller 64. Examples of corrupted or inaccurate data include data provided by a faulty sensor, input errors for the values of constants, and circuitry failure within the controller 64.

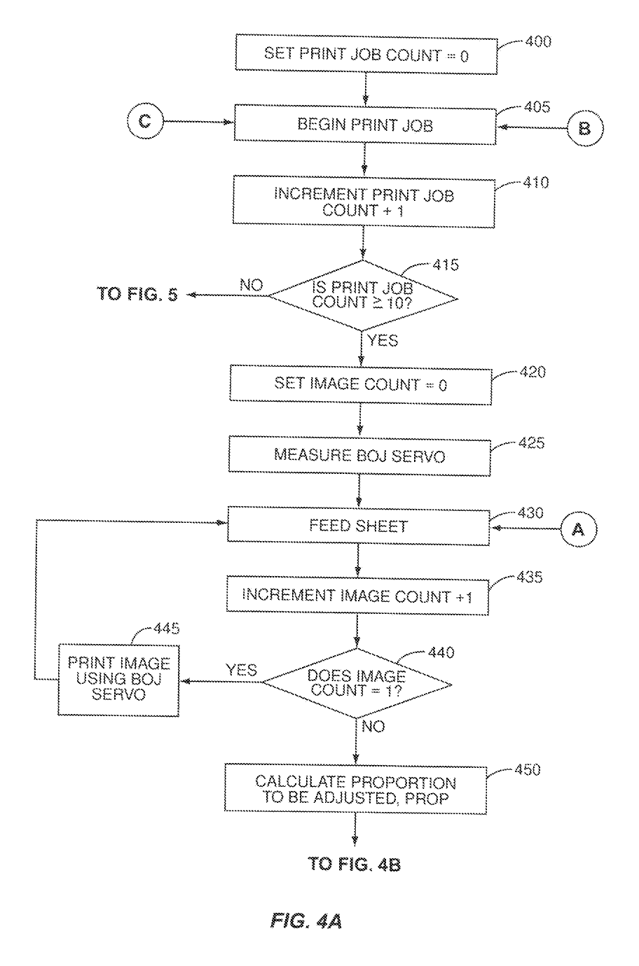

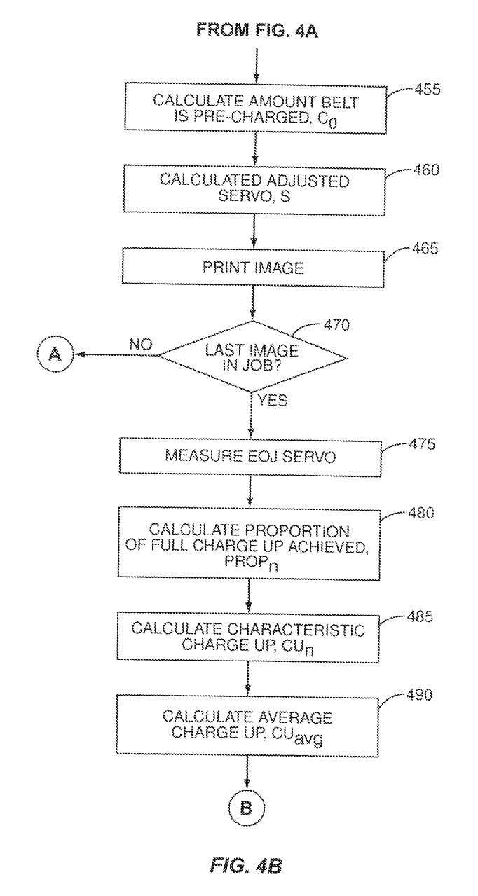

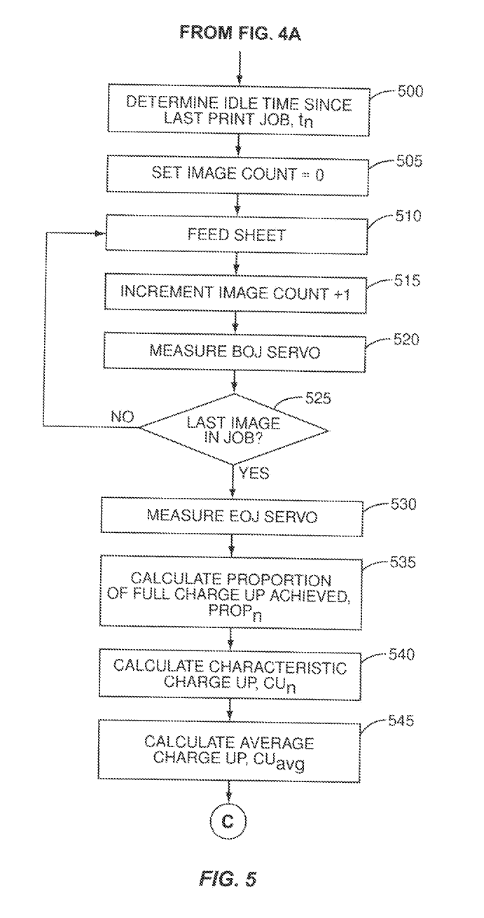

The operation of the controller 64 to perform the algorithm that takes into account both charge buildup and charge decay according to one embodiment is illustrated in FIGS. 4 and 5. In the first step, the controller sets the print job count to zero (block 400). A user then inputs a signal to the controller 64 to initiate a print job (block 405), and the controller 64 increments the print job count by one (block 410). The controller 64 compares the print job count to a predetermined value for the number of previous print job data sets stored by the controller 64 (block 415). In one embodiment, the predetermined number of data sets is 10.

In one embodiment when the print job count is less than the predetermined number, the controller 64 does not perform the servo adjustment algorithm until the predetermined number is reached. Until the predetermined number is reached, the controller 64 monitors each print job, records data describing the print job, and performs a number of calculations needed for the algorithm as illustrated in FIG. 5. When the print job count is less than the predetermined number (block 415, “no” branch), the controller 64 determines the idle time since the previous print job (block 500). The image count is set to zero for the current print job (block 505); the first sheet is fed (block 510) and the image count is incremented by one (block 515). A servo routine is performed to measure the beginning-of-job servo voltage (block 520). If the current image is not the last image in the print job (block 525), then the next sheet is fed (block 510) and the procedure is repeated. If the current image is the last image in the print job (block 525), then another servo routine is performed to measure the end-of-job servo voltage (block 530). The controller 64 then uses the data obtained for the current print job to calculate and store the proportion of full charge buildup achieved (block 535), characteristic charge buildup (block 540), and the average charge buildup (block 545). Upon receiving a signal from the user, the controller 64 begins the next print job (block 405).

Referring to FIG. 4, when the print job count equals or exceeds the predetermined number of print jobs (block 415, “yes” branch), the controller 64 begins the servo adjustment algorithm. The image count is set to zero (block 420), and a servo routine is performed to measure the beginning-of-job servo voltage (block 425). The first sheet is fed (block 430) and the image count is incremented by one (block 435). If the image count equals one (block 440, “yes” branch), the image is printed using the beginning-of-job servo voltage (block 445), and the next sheet is fed (block 430). If the image count does not equal one (block 440, “no” branch), the controller calculates the proportion of the full charge buildup to be adjusted (block 450), the amount the belt is precharged (block 455, FIG. 4B), and the adjusted transfer voltage (block 460). The image is then printed on the media sheet 12 using the adjusted transfer voltage (block 465). If additional images remain to be printed in the print job (block 470, “no” branch), then the next sheet is fed (block 430) and the procedure is repeated. If the last image printed was the last image in the print job (block 470, “yes” branch), then an end-of-job servo routine is performed (block 475). The controller 64 then calculates and stores the proportion of full charge buildup achieved (block 480), the characteristic charge buildup (block 485), and the average charge buildup (block 490). Upon receiving a signal from the user, the controller 64 begins the next print job (block 405).

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of dynamically compensating for transfer belt charge buildup in an image forming device, comprising:
printing a first image of a multi-image print job using a first transfer voltage;
determining the charge that builds up on the belt due to an applied transfer voltage; and
printing each of one or more subsequent images in the multi-image print job at one or more adjusted transfer voltages that compensate for the charge buildup on the belt due to the applied transfer voltages of the previous images.

2. The method of claim 1, wherein determining the charge that builds up on the belt comprises determining a first servo voltage for the belt in a fully discharged state; applying a transfer voltage to the belt which builds a charge on the belt; determining a second servo voltage for the charged belt; and subtracting the second servo voltage from the first servo voltage.

3. The method of claim 1, wherein determining the charge that builds up on the belt comprises performing an end-of-job servo routine.

4. The method of claim 3, wherein the step of performing an end-of-job servo routine comprises performing the end-of-job servo routine essentially simultaneously for black, magenta, and cyan image forming units when a media sheet on which the image is being printed leaves the penultimate image forming unit.

5. The method of claim 4, wherein the charge buildup for a last image forming unit is the same as the charge buildup for the penultimate image forming unit.

6. The method of claim 5, wherein the charge buildup for each print job is entered into a data set, and the charge buildup for a subsequent print job is extrapolated using the data set based on a number of images in the subsequent print job.

7. A method of dynamically compensating for transfer belt charge buildup in an image forming device, comprising:
accumulating a data set for a predetermined number of previous print jobs and calculating an average charge buildup on the belt;
determining an initial transfer voltage;
printing a first image of a multi-image print job at the initial transfer voltage; and
adjusting the transfer voltage for printing one or more subsequent images in the multi-image print job based on the calculated average charge buildup.

8. The method of claim 7, wherein adjusting the transfer voltage comprises increasing the initial transfer voltage by a fraction of the charge buildup based on an image number in the multi-image print job.

9. The method of claim 8, wherein increasing the initial transfer voltage comprises:
determining belt charge buildup constants;
measuring and storing transfer voltages and print job characteristics for each of a predetermined number of previous print jobs;
calculating charge buildup properties for each of the predetermined number of previous print jobs;
calculating an average characteristic charge buildup (CU_{avg}) for the predetermined number of previous print jobs; and
dynamically determining the charge buildup on the belt by determining a charge built up on the belt by a prior print job and subtracting the charge decayed from the belt over time.

10. The method of claim 9, wherein determining the belt charge buildup constants comprises determining a belt charging logarithmic base (e_{c}), a belt charging time constant (τ_{c}), a belt discharging time constant (τ_{d}), and an extrapolation time for predicting an amount of pre-charge (text);
and wherein measuring and storing transfer and print job characteristics comprises determining a beginning-of-job servo voltage for a most recent job number “n” (BOJₙ), an end-of-job servo voltage for the most recent job number “n” (EOJₙ), a number of images for the most recent job number “n” (PLₙ), an idle time prior to the most recent job number “n” (tₙ), a starting servo voltage for a current job (V1), and an idle time since the most recent job number “n” (t₁)

11. The method of claim 10, wherein calculating the charge buildup properties comprises calculating a proportion of full charge buildup achieved in a number of images printed in job number “n” (Propₙ) using Equation 1 and a characteristic charge buildup of the belt predicted by job number “n” (CUₙ) using Equations 2 and 3,
$$\begin{matrix}{Prop}_{n} = 1.0 - {e}_{c}^{- ( {PL}_{n} / {τ}_{c} )} & Eqn . 1 \\ {τ}_{d} = ( 0.027 \times C S S ) - 18.816 & Eqn . 2 \\ C {U}_{n} = - {τ}_{d} \times ln ( \frac{{t}_{n}}{{t}_{ext}} ) + \frac{E O {J}_{n} - B O {J}_{n}}{{Prop}_{n}} & Eqn . 3\end{matrix}$$

12. The method of claim 11, wherein dynamically determining the charge buildup on the belt comprises calculating a proportion of full charge buildup (Prop) for the image number being printed (P) using Equation 4, an amount the belt is “pre-charged” for the current job (C₀) using Equation 5, and a servo voltage for the image being printed (S) using Equation 6,
$$\begin{matrix}Prop = 1 - {e}_{c}^{- ( P / {τ}_{c} )} & Eqn . 4 \\ {C}_{0} = - {τ}_{d} \times ln ( \frac{{t}_{1}}{{t}_{ext}} ) & Eqn . 5 \\ S = V 1 + ( Prop \times ( C {U}_{avg} - {C}_{0} ) ) & Eqn . 6\end{matrix}$$

13. The method of claim 9, wherein increasing the initial transfer voltage for the image being printed is performed for each image transfer unit in the image forming device.

14. The method of claim 7, further comprising adding information obtained during printing of the current print job to the data set and removing an oldest entry from the data set to maintain a number of entries in the data set at the predetermined number.

15. The method of claim 7, wherein the step of determining an initial transfer voltage comprises performing a servo routine to measure a resistance across a transfer roller and the belt.

16. A image forming device, comprising:
a transfer belt;
an image transfer roller applying a variable transfer voltage to the belt;
memory for storing an accumulated data set; and
a controller operative to calculate the transfer voltage for a current image based on an average charge buildup and an image number of a current print job.

17. The image forming device of claim 16, wherein the controller is further operative to determine an initial transfer voltage for a first image of the current print job by performing a servo routine to measure a resistance across the transfer belt and the transfer roller.

18. The image forming device of claim 16, wherein the accumulated data set comprises for each of a predetermined number of previous print jobs, a beginning-of-job servo, an end-of-job servo, a number of images, a pre-job idle time, a proportion of full charge buildup achieved, a characteristic charge buildup of the belt predicted for the print job, and an average characteristic charge buildup for the predetermined number of previous print jobs.

19. The image forming device of claim 16, wherein the controller is further operative to dynamically determine the charge buildup on the belt by determining a charge built up on the belt by a prior print job and subtracting the charge decayed from the belt over time by calculating a proportion of full charge buildup for the image being printed, an amount the belt is “pre-charged” for the current job, and a servo voltage for the image being printed.

20. The image forming device of claim 19, wherein the controller is further operative to calculate the transfer voltage for a current image for each of the more than one image transfer rollers.
